(19) United States
(12) Patent Application Publication
(10) Pub. No.: US 2007/0270308 A1
(43) Pub. Date: Nov. 22, 2007

(54) Tape with thermochromic member

(76) Inventors: Yutaka Yokoyama, Taipei (TW); Lin Chin Hung, Taipei (TW)

Correspondence Address: Michael S. Leonard;Everest Intellectual Property Law Group, P.O. Box 708, Northbrook, IL, 60065, US

(21) Appl. No.: 11/804,669

(22) Filed: May 18, 2007

(30) Foreign Application Priority Data
May 19, 2006 (JP) P2006-140678

(51) Int. Cl. B41M 5/24

(52) U.S. Cl. 503/201

(57) ABSTRACT

A tape with a thermochromic member includes: a tape body; a figure, provided on the tape body; and a thermochromic member, adapted to change between a colored state and a transparent state according to changes of temperature and attached to the tape body so as to cover the figure. The figure can be seen through the thermochromic member when the thermochromic member is in the transparent state.

### BACKGROUND OF THE INVENTION

The present invention relates to a tape with a thermochromic member in which a figure drawn on a tape of various types such as a tape of a slide fastener, a back face of an attachment fastener, a tape of a snap fastener, a tape of a belt, a tape in a strap, and a film or a tube formed of synthetic resin which covers this figure will change with a change of temperature.

There is, as shown in FIG. 14, a related slide fastener of which components such as fastener elements, upper and lower stoppers, an opening and separating insertion piece, a slider, a pulling tag formed of synthetic resin are formed by injection molding or extrusion molding, employing material containing heat sensitive coloring matter, so that colors of the components may change with a change of the temperature (see JP-A-1-216825).

In the related slide fastener as described above referring to FIG. 14, the components such as the fastener elements, upper and lower stoppers, opening and separating insertion piece, slider, pulling tag have been formed by injection molding or extrusion molding, employing the synthetic resin containing heat sensitive coloring matter, so that the colors of these components may change with a change of the temperature. Therefore, the related art is not concerned with such an idea that color of a figure provided on a fastener tape which is one of the components of the slide fastener may change with a change of the temperature.

In the components of the slide fastener as shown in FIG. 14, since they have various shapes and so they include various coloring parts, it is difficult to enhance the ornamentation thereof.

### SUMMARY

It is therefore an object of the invention to provide a tape with a thermochromic member in which a figure drawn on a tape of a slide fastener, a back face of an attachment fastener, a tape of a snap fastener, a tape of a belt, a tape in a strap or the like will change between a visible state and an invisible state, or color of the figure itself will change, according to changes of temperature, whereby a colorful tape which is ornamentally excellent and has not been in the related art can be obtained.

It is also an object of the invention to provide a tape with a thermochromic member in which a form of the material to be employed for changing the figure drawn on the tape between the visible state and the invisible state or for changing the color is specified, whereby the figure can be maintained in a stable manner.

It is also an object of the invention to provide a tape with a thermochromic member in which the color of the figure drawn on the tape and the color of the unfigured part are specified, and the colors of the figure and the unfigured part in the colored state are specified, whereby the colorful figure will be able to appear.

In order to achieve the object, according to the invention, there is provided a tape with a thermochromic member comprising:

a tape body;

a figure, provided on the tape body; and

a thermochromic member, adapted to change between a colored state and a transparent state according to changes of temperature and attached to the tape body so as to cover the figure, wherein
the figure can be seen through the thermochromic member when the thermochromic member is in the transparent state.

According to the invention, there is also provided a tape with a thermochromic member comprising:

a tape body; and

a figure, formed of a thermochromic member adapted to change between a colored state and a transparent state according to changes of temperature and attached to the tape body, wherein

the figure can be seen in the colored state.

The tape body may be seen through the thermochromic member when the thermochromic member is in the transparent state.

According to the invention, there is also provided a tape with a thermochromic member comprising:

a tape body; and

a figure, formed of a thermochromic member adapted to change between a first colored state and a second colored state according to changes of temperature and attached to the tape body, wherein
the figure can be distinguished from the tape body in one of the first colored state and the second colored state.

The thermochromic member may have a first color in the first colored state and a second color in the second colored state, and a color of the tape body may be identical with one of the first color and the second color.

The thermochromic member may have a shape of a film and be formed of synthetic resin, and the thermochromic member may be secured to the tape body.

The tape body may include unfigured part where the figure does not exist, the figure and the unfigured part may have different colors from each other, and a color of the thermochromic member in the colored state may be the same as or approximate to one of a color of the figure and a color of the unfigured part.

The thermochromic member may cover both the figure and the unfigured part.

The tape body may include a first portion on which the figure is provided and a second portion which is different from the first portion, the figure may have a first color and the second portion may have a second color different from the first color, and a color of the thermochromic member in the colored state may be identical with one of the first color and the second color.

The thermochromic member may cover at least the figure and the second portion on the tape body.

### BRIEF DESCRIPTION OF THE DRAWINGS

FIG. 1 is a perspective view of a slide fastener in Embodiment 1 of a tape with a thermochromic member according to the invention.

FIG. 2 is a sectional view of the slide fastener in Embodiment 1.

FIG. 3 is a view showing function of the slide fastener in Embodiment 1, before a temperature change.

FIG. 4 is a view showing function of the slide fastener in Embodiment 1, after the temperature change.

FIG. 5 is a perspective view of a slide fastener in Modification 1 of Embodiment 1.

FIG. 6 is a perspective view of a slide fastener in Modification 2 of Embodiment 1.

FIG. 7 is a perspective view of a slide fastener in Modification 3 of Embodiment 1.

FIG. 8 is a perspective view of an attachment fastener in Embodiment 2 of the tape with a thermochromic member.

FIG. 9 is a perspective view of a snap fastener in Embodiment 3 of the tape with a thermochromic member.

FIG. 10 is a perspective view of a belt in Embodiment 4 of the tape with a thermochromic member.

FIG. 11 is a perspective view of a strap in Embodiment 5 of the tape with a thermochromic member.

FIG. 12 is a sectional view of the strap in Embodiment 5.

FIG. 13 is a sectional view of a strap in a modification of Embodiment 5.

FIG. 14 is a plan view of a related slide fastener.

### DETAIL DESCRIPTION OF PREFERRED EMBODIMENTS

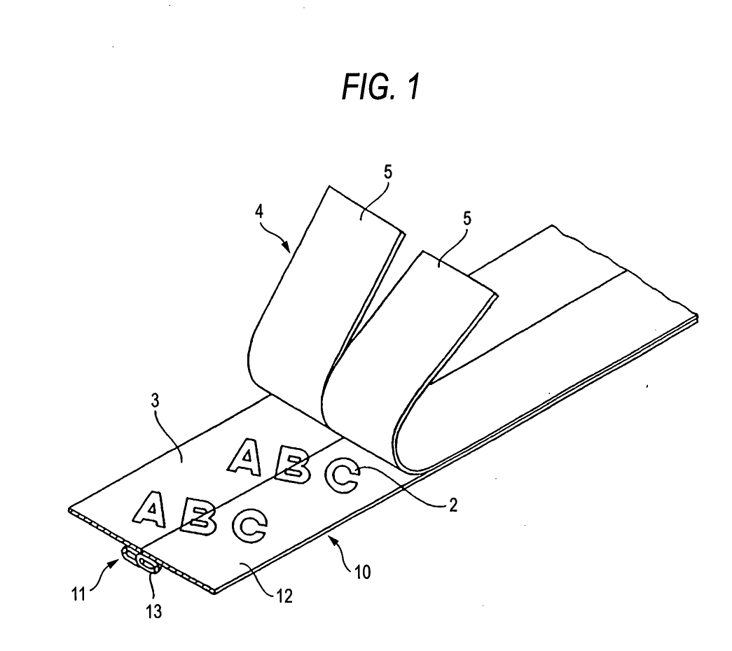

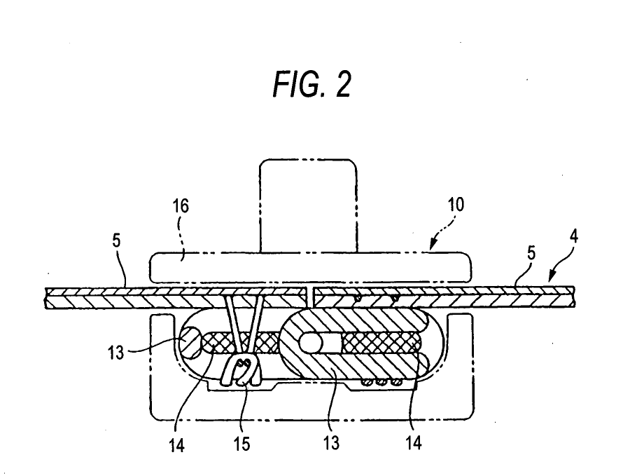

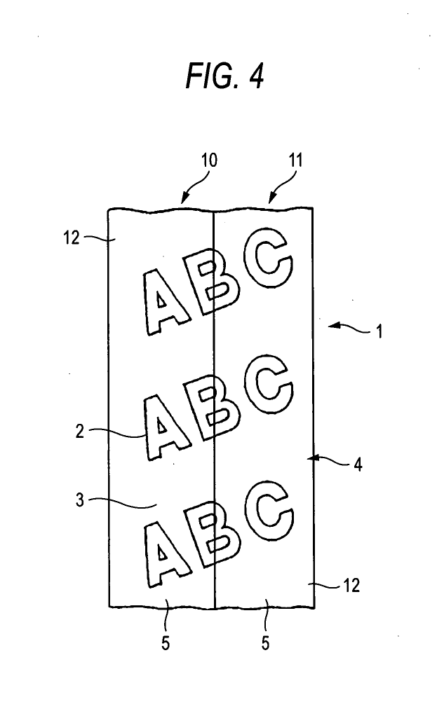

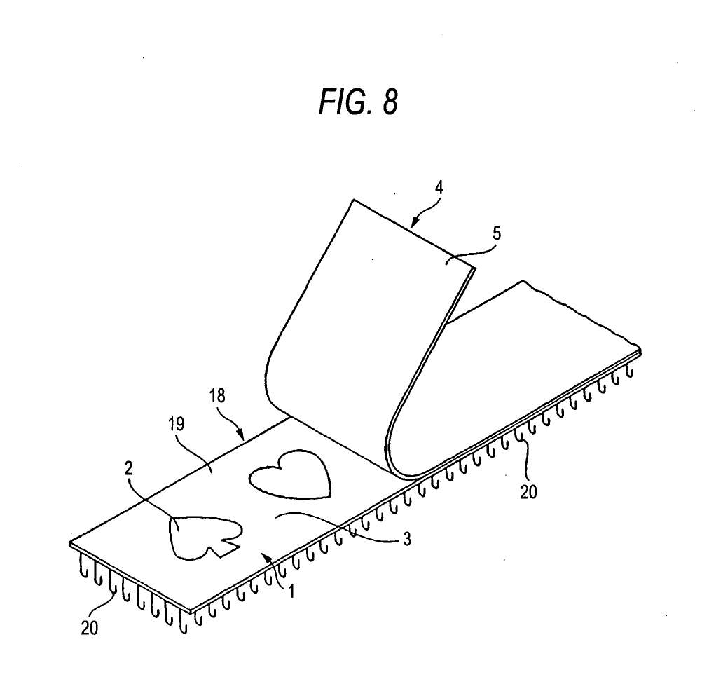

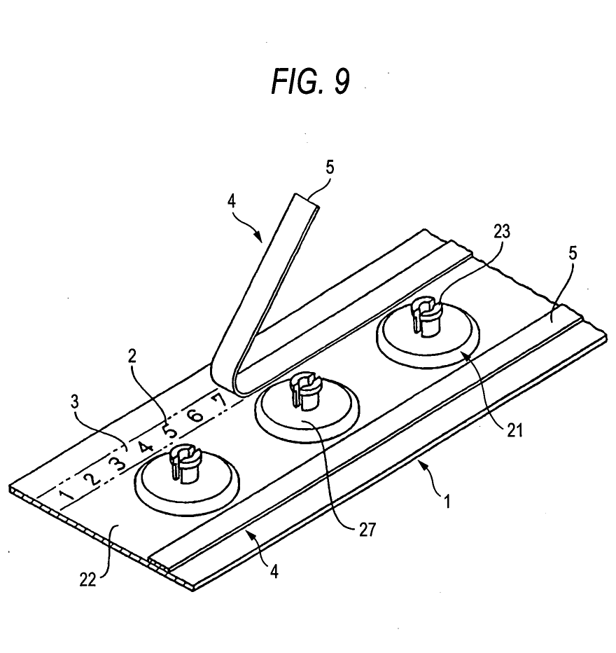

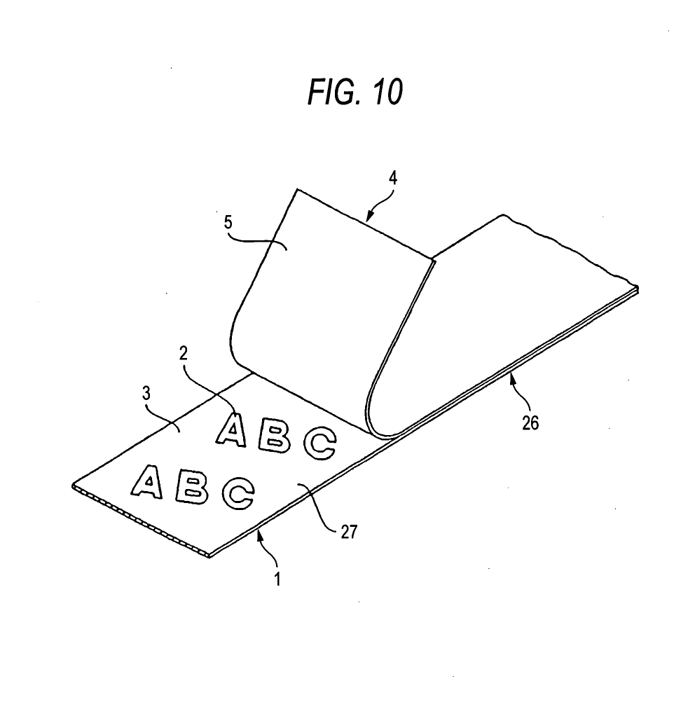

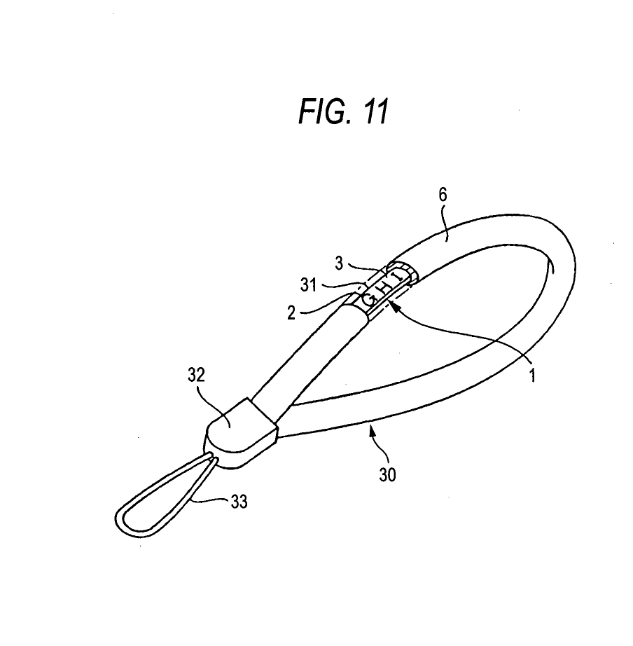

In a tape with a thermochromic member according to the invention, a film 5 formed of a thermochromic member 4 whose color will change with a change of temperature is attached to a tape 1 in each of products including a slide faster 10 as shown in FIGS. 1 to 7, an attachment faster 18 as shown in FIG. 8, a snap faster 21 as shown in FIG. 9, a belt 26 as shown in FIG. 10, and a strap 30 as shown in FIGS. 11 to 13, so that color of a figure 2 which is drawn on the tape 1 may change. To begin with, the invention will be described referring to an embodiment in which the tape with a thermochromic member is applied to a fastener tape 12 of the slide faster 10, as the tape 1 as shown in FIGS. 1 to 4.

The thermochromic member of this invention may be formed by employing a heat sensitive coloring matter which is a phenomenon that its color will reversibly change by heat (thermochromism), and will change in color when temperature rises above a determined temperature, and will revert to the original color when the temperature drops below the determined temperature. The coloring matter which can be favorably employed in the invention includes the heat sensitive coloring matter based on an electron donor-acceptor system in which color will change by thermal equilibrium between an electron donor and an electron acceptor in an organic compound, as described in JP-B-51-44706. By appropriately combining essential three components (leuco dye, phenol compound, and alcohols), it is possible to obtain a coloring matter which will change to a desired color at a desired temperature.

The thermochromic member may be formed by dispersing the heat sensitive coloring matter in a transparent resin such as acryl or urethane. However, in order to obtain the member which will be colored sensitively with a change of the temperature, it would be better to form a coloring layer containing the aforesaid heat sensitive coloring matter on a film of transparent resin. Specifically, the thermochromic member may be formed according to the method as described in JP-A-7-119056. The thermochromic member may be formed in such a manner that the temperature where the color starts to change may be set within a range from 0 to 65° C., and the color may change with a change of the temperature, from the colored state of various colors such as black, red, green, yellow, yellow green, purple, gray, orange, pink, etc. to a colorless transparent state. Alternatively, the colored state of either one of the aforementioned colors to the colored state of either one of the other colors, or from a dark colored state to a light colored state, that is, the thermochromic member may change to the colored transparent state when the color becomes light, even though both the dark colored state and the light colored state are the colored state. It is also possible to set a plurality of different determined temperatures so that the thermochromic member may change stepwise into colors of three types or more with differences in temperature.

In the slide fastener 10 as shown in FIGS. 1 to 4, a row of fastener elements 13 in a spiral shape with a core cord 14 inserted therein will be sewed to a face of a fastener tape 12 at its one side edge with a sewing string 15 of double loop sewing. Right and left rows of the fastener elements 13 will be meshed with each other by means of a slider 16 thereby to form a fastener chain 11. Figures 2 of various types will be drawn on the face of the fastener tapes 12 where the rows of the fastener elements 13 of the fastener chain 11 do not exist. The figures 2 and unfigured parts 3 which have no FIG. 2 will be formed in respectively different colors.

Then, films 5 formed of the thermochromic member 4 are covered over the surfaces of the fastener tapes 12 by bonding or pasting so as to cover all over the figures 2 and the unfigured parts 3 which have no FIG. 2, as shown in FIGS. 1 and 2.

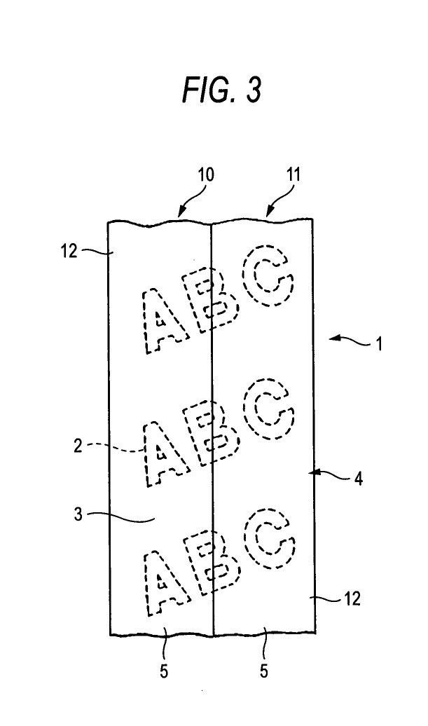

When the temperature is low, the films 5 are colored to a dark color. Therefore, the fastener tapes 12 which are covered with the films 5 of the thermochromic member 4 are in the colored state having the same color, and both the figures 2 drawn on the fastener tapes 12 and the unfigured parts 3 cannot be seen, as shown in FIG. 3. As the temperature rises to reach the determined temperature, the films 5 will be discolored and become transparent. Then, the figures 2 which have been drawn on the fastener tapes 12 and the unfigured parts 3 can be clearly discriminated by colors through the films 5, and the colorful fastener tapes 12 can be obtained.

### Embodiment 1

The tape with the thermochromic member in Embodiment 1 as shown in FIGS. 1 to 4 has such a structure as described in the preceding passages. Specifically, the two rows of the fastener elements 13 in a spiral shape with the core cords 14 inserted therein are sewed to the back faces of the right and left fastener tapes 12 of the slide fastener 10 along their opposed side edges with the sewing strings 15 of double loop sewing, and the right and left rows of the fastener elements 13 are meshed with each other by means of the slider 16 thereby to form the fastener chain 11. The figures 2 are drawn by embroidering or jacquard weaving on the surfaces of the fastener tapes 12 where the rows of the fastener elements 13 of the fastener chain 11 do not exist. The figures 2 and the unfigured parts 3 which have no figures 2 are formed in respectively different colors. It is to be noted that although letters are used as the figures 2 in this embodiment, numerals, diagrams, figures, etc. may be used besides the letters.

Then, the figures 2 drawn on the right and left fastener tapes 12 and the unfigured parts 3 which have no figures 2 will be covered all over with a pair of the right and left films 5 formed of the thermochromic member 4. This thermochromic member 4 is formed, as described above, by forming the coloring layer containing the heat sensitive coloring matter on the film 5 of transparent resin such as polyurethane, and it is so set that the thermochromic member may be colored at the lower temperature than the determined temperature, and may be discolored at the higher temperature than the determined temperature to become transparent, whereby the color of the film 5 will change according to changes of the temperature. Preferably, the temperature where the color of the thermochromic member 4 starts to change is set to be 30 to 35 degrees (° C.) so that the color may change with a rise of body temperature, in case where the thermochromic member 4 is attached to an article to be worn on a human body. The films 5 will be covered over the surfaces of the right and left fastener tapes 12 by bonding or pasting with bonding agent or by ultrasonic process.

Ordinarily, the thermochromic member 4 is in the colored state, and the color of the fastener tapes 12, to say nothing of the figures 2 drawn on the fastener tapes 12, cannot be seen through the thermochromic member 4. As the temperature rises to reach the determined temperature, the color will gradually vanish and become transparent at the determined temperature, whereby the figures 2 drawn on the right and left fastener tapes 12 and the unfigured parts 3 will be able to be seen through the thermochromic member 4. Moreover, the color of the figures 2 or the unfigured parts 3 may be made the same as or approximate to the color of the thermochromic member 4 in the colored state, which will give such visual effect that the figures 2 or the unfigured parts 3 will appear from the color surrounding them, when the thermochromic member 4 has become colorless and transparent.

Moreover, it is possible to change the determined temperature of the thermochromic member 4, by varying an amount of the heat sensitive coloring matter contained therein. It is also possible to form the thermochromic member 4 so as to be transparent at the ordinary low temperature, and to gradually become colored as the temperature approaches the determined temperature. It is also possible to form the thermochromic member 4 so as to change from a colored state having a dark color to a colored transparent state having a light color, for example, to change from dark red to light pink. In this manner, the figures 2 can be seen through the thermochromic member 4 in the colored transparent state.

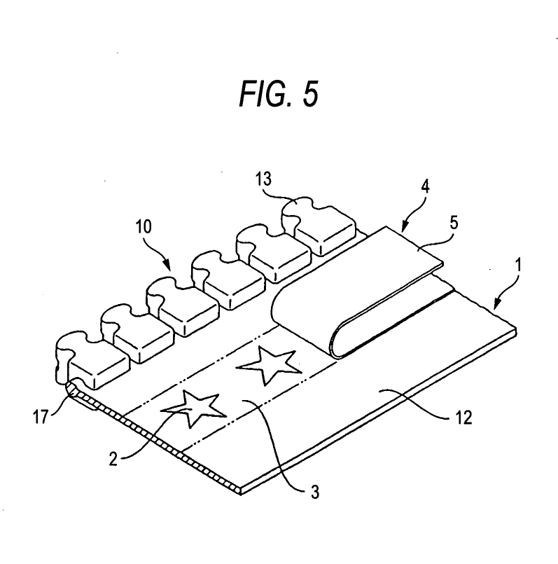

Modification 1 of Embodiment 1 as shown in FIG. 5 includes the slide fastener 10 in which a swelled part 17 is formed along a side edge on the surface of the fastener tape 12, and the fastener elements 13 of a single type are formed on this swelled part 17 employing synthetic resin, by injection molding or extrusion molding. This slide fastener 10 has star-shaped figures 2 which are drawn on the surface of each of the right and left fastener tapes 12 in a spotted manner in a longitudinal direction of a center part thereof. The film 5 of the thermochromic member 4 in a strip shape having a smaller width than the fastener tape 12 is bonded or pasted to the fastener tape 12 so as to cover the figures 2 and the unfigured part 3 surrounding the figures 2. The thermochromic member 4 has the color same as or approximate to the color of the fastener tape 12 in its colored state, while the figures 2 are drawn in a color different from the colors of the fastener tape 12 and the thermochromic member 4 in the colored state. According to this structure, the figures cannot be seen through the thermochromic member 4, when the thermochromic member 4 is in the colored state, and the slide fastener 10 has a single color which is unified by the colors of the fastener tape 12 and the thermochromic member 4. When the thermochromic member 4 has changed from the colored state to the colorless transparent state, it is possible to see the figures 2 through the thermochromic member 4. In case where the unfigured part 3 has the same color as the fastener tape 12, the surface of the fastener tape 12 will be discriminated into two colors, that is, the color of the fastener tape 12 including the unfigured part 3 and the color of the figures 2, when the thermochromic member 4 has come into the colorless transparent state. Moreover, by making the color of the unfigured part 3 different from the colors of the fastener tape 12 and the figures 2, it is possible to see three colors on the surface of the fastener tape 12, when the thermochromic member 4 has come into the colorless transparent state.

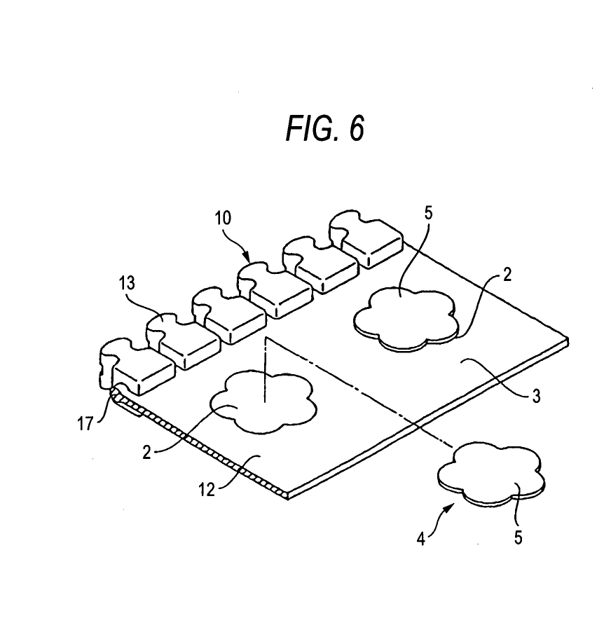

Modification 2 of Embodiment 1 as shown in FIG. 6 includes the slide fastener 10 in which the swelled part 17 is formed along the side edge on the surface of the fastener tape 12, and the fastener elements 13 of a single type are formed on this swelled part 17 employing synthetic resin, by injection molding or extrusion molding, in the same manner as in the previous modification. This slide fastener 10 has flower-shaped figures 2 which are drawn on the surfaces of the right and left fastener tapes 12 in a spotted manner in a longitudinal direction thereof. The films 5 of the thermochromic member 4 having the same shape as the figures 2 or a rather larger shape than the figures 2 will be formed so as to cover only the figures 2, and will be covered over the surfaces of the fastener tapes 12 by bonding or pasting.

By forming the slide fastener in this manner, the figures 2 and the unfigured parts 3 are formed on the right and left fastener tapes 12, and the films 5 of the thermochromic member 4 are covered over the figures 2. Therefore, as the temperature changes, the figures 2 which have been drawn on the surfaces of the fastener tapes 12 can be seen through the films 5 which have been bonded or pasted to the surfaces of the figures 2.

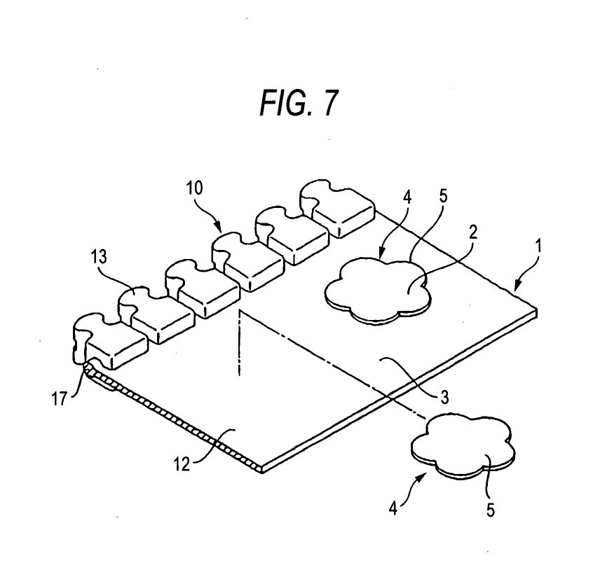

Modification 3 of Embodiment 1 as shown in FIG. 7 includes the slide fastener 10 in which the swelled part 17 is formed along the side edge on the surface of the fastener tape 12, and the fastener elements 13 of a single type is formed on this swelled part 17 employing synthetic resin, by injection molding or extrusion molding, in the same manner as in the previous modification. In this slide fastener 10, the right and left fastener tapes 12 are formed unfigured, and the films 5 of the thermochromic member 4 in a flower shape are formed. For the purpose of showing these films 5 as the figures 2, the films will be bonded or pasted to the surfaces of the right and left unfigured fastener tapes 12 thereby to form the figures 2. The shape of the figures 2 is not limited to the flower shape, but the figures 2 may be formed in a shape of star, arrow mark, and so on.

By forming the slide fastener in this manner, the figures 2 and the unfigured parts 3 are formed on the right and left fastener tapes 12, and the figures 2 are formed of the films 5 of the thermochromic member 4. Therefore, color change of the figures 2 which have been formed on the surfaces of the fastener tapes 12 can be easily performed with a change of the temperature. When the temperature is low, the thermochromic member 4 will be colored to show the color of the figures 2 on the fastener tape 12, and as the temperature rises to reach the determined temperature, the thermochromic member 4 will be turned into colorless transparent state, so that the color of the figures 2 cannot be seen. It is also possible to reverse this phenomenon. Moreover, it is also possible to change the color of the thermochromic member 4 from the colored state in one color to the colored state in another color, for example from purple to blue, from orange to red, from green to blue, and so on. In this case, the color of the thermochromic member 4 before the color change may be made the same as or approximate to the color of the fastener tape 12, and the color of the thermochromic member 4 after the color change may be made different from the color of the fastener tape 12, whereby the figures 2 which were unable to be seen before the color change will be able to be seen after the color change. In other words, the figures of the thermochromic member 4 cannot be distinguished from the unfigured parts 3 of the fastener tape 12 before the color change, but the figures can be distinguished from the unfigured parts 3 after the color change. It is also possible to form the thermochromic member 4 so as to change in three colors or more according to differences of the temperature, for example, from green to red and to yellow, or gray to yellow-green and to yellow.

### Embodiment 2

The tape with a thermochromic member in Embodiment 2 as shown in FIG. 8 is concerned with the attachment fastener 18. Hook-shaped locking elements 20, loop-shaped locking elements or the hook-shaped locking elements 20 mixed with the loop-shaped locking elements are planted on one face of an attachment fastener tape 19 of the attachment fastener 18. figures 2 in a shape of heart or spade are drawn on an opposite face of the attachment fastener tape 19 where the locking elements 20 are not provided, and unfigured parts 3 where the figures 2 do not exist are formed between the figures 2. The film 5 formed of the thermochromic member 4 is covered all over the figures 2 and the unfigured parts 3 by bonding or pasting so that the color of the films 5 may change with a change of the temperature. In this manner, it is possible to produce the colorful attachment fastener 18 in which the figures 2 and the unfigured parts 3 can be seen through the films 5. It is also possible to make a width of the films 5 smaller so that the figures 2 which have been drawn on the attachment fastener tape 19 and the unfigured parts 3 may be partially covered. The figures may be in a simple shape such as a circle, triangle, quadrangle and so on.

### Embodiment 3

The tape with a thermochromic member in Embodiment 3 as shown in FIG. 9 is concerned with the snap fastener 21. In the snap fastener 21, bases 24 of male engaging parts 23 are fitted to a snap fastener tape 22 in a longitudinal direction of a center part thereof, and figures 2 in a shape of numerals are drawn in both side areas of the snap fastener tape 22, leaving unfigured parts 3 between the figures 2. Films 5 in a shape of narrow strip formed of the thermochromic member 4 are covered over the figures 2 and the unfigured parts 3 in both the side areas of the snap fastener tape 22 by bonding or pasting so that the color of the films 5 may change with a change of the temperature. In this manner, it is possible to produce the colorful snap fastener 21 in which the figures 2 and the unfigured parts 3 can be seen through the films 5. It is also possible to apply this embodiment to a snap fastener of a type that bases of female engaging parts of the snap fastener are provided in the longitudinal direction in the center part of the snap fastener tape.

### Embodiment 4

The tape with a thermochromic member in Embodiment 4 as shown in FIG. 10 is concerned with the belt 26 which is used as an adjusting belt or a shoulder belt. Figures 2 in a shape of letters are drawn on a surface of a tape 27 for the belt, and unfigured parts 3 where the figures 2 do not exist are formed. A film 5 formed of the thermochromic member 4 having the same width as the tape 27 for the belt will be covered over the figures 2 and the unfigured parts 3 by bonding or pasting so that the color of the film 5 may change with a change of the temperature. In this manner, it is possible to produce the colorful belt 26 in which the figures 2 and the unfigured parts 3 can be seen through the films 5.

### Embodiment 5

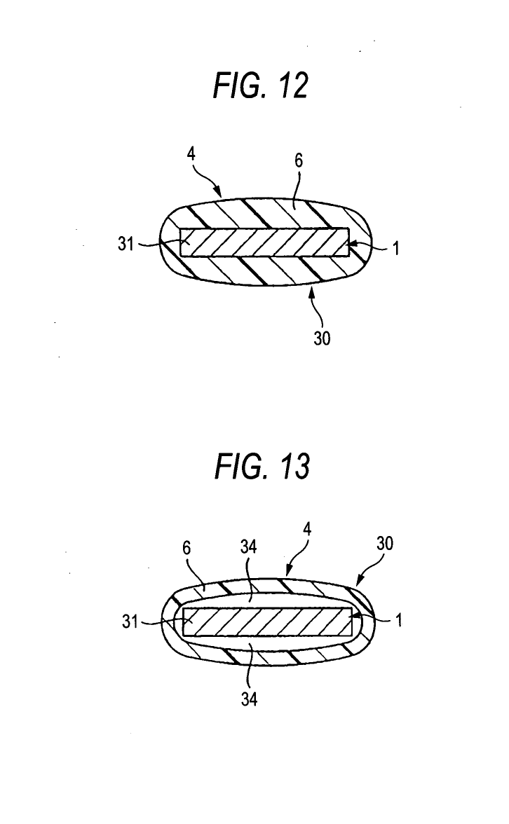

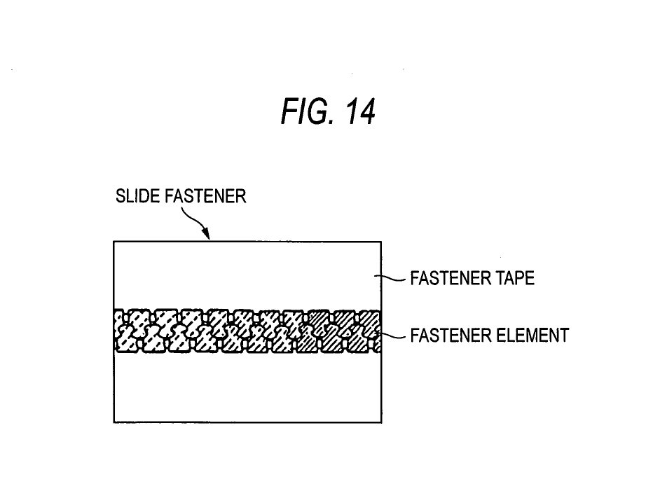

The tape with a thermochromic member in Embodiment 5 as shown in FIGS. 11 and 12 is concerned with the strap 30 which is applied to a carrying strap for a portable article such as a portable phone. Figures 2 in a shape of letters are drawn on one face or both faces of a strap tape 31 which is used as a core member of the strap 30, and unfigured parts 3 where the figure do not exist are formed between the figures 2. A tube 6 formed of the thermochromic member 4 will be covered over the strap tape 31 in a manner of grasping the strap tape 31, and the tube 6 is bonded or pasted to the strap tape 31. Alternatively, the tube 6 may be injection molded around the strap tape 31 thereby to integrally form the strap 30. This strap 30 will change in color as the temperature changes, and it is possible to produce the colorful strap 30 in which the figures 2 which have been drawn on the strap tape 31 incorporated therein and the unfigured parts 3 can be seen through the tube 6. The strap will be wound in a ring-like shape and secured by a coupling part 32, and then, attached to the portable article such as the portable phone for use, by means of an attaching cord 33 which is fixed to the coupling part 32.

In a modification of Embodiment 5 as shown in FIG. 13, the strap tape 31 as the core member to be incorporated in the strap 30 is not integrally formed with the tube 6 formed of the thermochromic member 4 by bonding or pasting. Alternatively, a receiving space 34 into which the strap tape 31 can be inserted may be formed in the tube 6.

According to an aspect of the invention, the figure is provided on the tape, and the thermochromic member which will change between the colored state and the transparent state according to changes of the temperature is attached to the tape so as to cover the figure, whereby the tape will be formed in such a manner that the figure can be seen through the thermochromic member when it is in the transparent state. As the results, the invention achieves the following advantages.

In the tape with a thermochromic member, the color of the figure which has been drawn on the tape of various types such as the fastener tape, the back face of the attachment fastener, the tape of the snap fastener, the tape of the belt, the tape in the strap will easily change according to changes of the temperature. As the results, it is possible to realize a beautiful and colorful tape in which the figure inside can be seen through the thermochromic member, particularly when the thermochromic member which covers the tape has changed to be transparent.

According to an aspect of the invention, the figure is formed of the thermochromic member which will change between the transparent state and the colored state according to changes of the temperature, and the figure is attached to the tape, whereby the tape will be formed in such a manner that the figure can be seen when the thermochromic member is in the colored state. Therefore, because the figure to be provided on the tape of various types is formed by directly cutting out the thermochromic member whose color will change according to changes of the temperature, the figure can be produced very easily, and hence, a beautiful and colorful tape can be realized.

According to an aspect of the invention, the figure is formed of the thermochromic member which will change in the colored state according to changes of the temperature, and the tape will be formed in such a manner that the figure can be distinguished from the tape, in the colored state, after the temperature has changed. Because the figure provided on the tape of various types has been formed of the thermochromic member which will change in the colored state according to the changes of the temperature, it is possible to clearly distinguish the figure from the unfigured part after the change of the temperature, even though it has been difficult to distinguish the figure from the unfigured part before the change of the temperature, and hence, a beautiful and colorful tape can be realized.

According to an aspect of the invention, the thermochromic member is formed in a form of the film of synthetic resin, and bonded or pasted to an opposed face of the tape. Because the thermochromic member is formed in a form of the film of synthetic resin, production of the thermochromic member is extremely easy. Moreover, the thermochromic member can be fixed to the tape in a stabilized manner, since it is bonded or pasted to the tape of various types.

According to an aspect of the invention, the thermochromic member covers both the figure existing on the tape and the unfigured part where the figure does not exist, the figure and the unfigured part having respectively different colors, and the color of the thermochromic member in the colored state is the same as or approximate to the color of the figure or the color of the unfigured part. Because the thermochromic member covers both of the figured part and the unfigured part which have respectively different colors, the surface of the tape will be flat and can be finished beautifully. Moreover, because the figure can clearly appear when the thermochromic member is in the transparent state, and the figured part cannot be distinguished from the unfigured part when the thermochromic member is in the colored state, it is possible to finish the tape into a changeful tape. In this manner, advantages achieved by this invention are extremely prominent.

The tape with a thermochromic member according to the invention can be applied to the fastener tape of the slide fastener, the attachment fastener, the snap fastener tape on which the snap fasteners are provided, the adjusting belt or shoulder belt, the carrying cord for the portable article such as the portable phone. Therefore, it is possible to produce the colorful tape, belt, cord or the like.

What is claimed is:

1. A tape with a thermochromic member comprising:
a tape body;
a figure, provided on the tape body; and
a thermochromic member, adapted to change between a colored state and a transparent state according to changes of temperature and attached to the tape body so as to cover the figure, wherein
the figure can be seen through the thermochromic member when the thermochromic member is in the transparent state.

2. A tape with a thermochromic member comprising:
a tape body; and
a figure, formed of a thermochromic member adapted to change between a colored state and a transparent state according to changes of temperature and attached to the tape body, wherein
the figure can be seen in the colored state.

3. A tape with a thermochromic member comprising:
a tape body; and
a figure, formed of a thermochromic member adapted to change between a first colored state and a second colored state according to changes of temperature and attached to the tape body, wherein
the figure can be distinguished from the tape body in one of the first colored state and the second colored state.

4. The tape as set forth in claim 1, wherein
the thermochromic member has a shape of a film and is formed of synthetic resin, and
the thermochromic member is secured to the tape body.

5. The tape as set forth in claim 2, wherein
the thermochromic member has a shape of a film and is formed of synthetic resin, and
the thermochromic member is secured to the tape body.

6. The tape as set forth in claim 1, wherein
the tape body includes unfigured part where the figure does not exist,
the figure and the unfigured part have different colors from each other, and
a color of the thermochromic member in the colored state is the same as or approximate to one of a color of the figure and a color of the unfigured part.

7. The tape as set forth in claim 6, wherein
the thermochromic member covers both the figure and the unfigured part.

8. The tape as set forth in claim 1, wherein
the tape body includes a first portion on which the figure is provided and a second portion which is different from the first portion,
the figure has a first color and the second portion has a second color different from the first color,
and
a color of the thermochromic member in the colored state is identical with one of the first color and the second color.

9. The tape as set forth in claim 7, wherein
the thermochromic member covers at least the figure and the second portion on the tape body.

10. The tape as set forth in claim 2, wherein
the tape body can be seen through the thermochromic member when the thermochromic member is in the transparent state.

11. The tape as set forth in claim 3, wherein
the thermochromic member has a first color in the first colored state and a second color in the second colored state, and
a color of the tape body is identical with one of the first color and the second color.
